(19) United States
(12) Patent Application Publication
(10) Pub. No.: US 2016/0376946 A1
(43) Pub. Date: Dec. 29, 2016

(54) VALVE TIMING CONTROL DEVICE FOR INTERNAL COMBUSTION ENGINE AND CONTROLLER FOR VALVE TIMING CONTROL DEVICE

(71) Applicant: HITACHI AUTOMOTIVE SYSTEMS, LTD., Hitachinaka-shi (JP)

(72) Inventor: Mikihiro KAJIURA, Tama-shi (JP)

(73) Assignee: HITACHI AUTOMOTIVE SYSTEMS, LTD., Hitachinaka-shi (JP)

(21) Appl. No.: 15/100,040

(22) PCT Filed: Dec. 15, 2014
(86) PCT No.: PCT/JP2014/083086

§ 371 Date: May 27, 2016

(30) Foreign Application Priority Data
Dec. 19, 2013 (JP) 2013-261932

(51) Int. Cl. F01L 1/356; H02K 1/12; H02K 7/00; H02K 13/00; H02K 7/075; H02K 13/14; H02K 5/14; H02P 29/024; H02P 7/06; H02K 1/26; H02K 13/10

(52) U.S. Cl. CPC F01L 1/356; H02K 1/26; H02K 1/12; H02K 7/006; H02K 13/003; H02K 13/10; H02K 13/14; H02K 5/148; H02P 29/024; H02P 7/06; H02K 7/075; F01L 2800/11

(57) ABSTRACT

Provided is an electric-motor-driven valve timing control device for an internal combustion engine with which the valve timing control device can be operated even when a portion of coils of an electric motor has broken. The electric motor has two systems of switching brushes, each system being constructed by a set of positive-electrode and negative-electrode switching brushes. When an electricity-feeding line used for electricity-feeding to one system of the two systems has broken, the valve timing control device is configured to stop energization to the other system or reduce an energization amount to the other system, after having energized the other system of switching brushes until such time that a predetermined time has expired from a start of the engine, thus enabling the relative rotational phase of a camshaft to be converted to a phase suitable for starting.

### TECHNICAL FIELD

The present invention relates to a valve timing control device for an internal combustion engine for controlling operating characteristics of intake valves and/or exhaust valves of the internal combustion engine, and specifically to a controller for the valve timing control device.

### BACKGROUND ART

Recently provided is a valve timing control device for controlling intake-valve open and closure timings and/or exhaust-valve open and closure timings by converting a relative rotational phase of a camshaft to a crankshaft by a rotational driving force of an electric motor.

For instance, a prior art valve timing control device as described in the following Patent document 1 is configured to reduce an electric power consumption as much as possible by energizing an electric motor through the use of electricity-feeding brushes and slip rings, only when intake-valve open and closure timings and/or exhaust-valve open and closure timings have to be changed.

### CITATION LIST

### Patent Literature

Patent document 1: JP2012-132367 A

### SUMMARY OF INVENTION

### Technical Problem

However, the previously-discussed prior art valve timing control device suffers from such problem that the valve timing control device cannot be controlled when the coil of an electric motor has broken due to some cause.

It is, therefore, in view of the previously-described drawbacks of the prior art, an object of the invention to provide a valve timing control device for an internal combustion engine with which the valve timing control device can be operated, even when a portion of coils of an electric motor has broken due to some cause.

### Solution to Problem

In order to accomplish the aforementioned and other objects, according to the present invention as recited in claim 1 of the claimed invention, a valve timing control device for an internal combustion engine for changing a relative rotational phase of a camshaft to a crankshaft by energizing coils of an electric motor, characterized in that the electric motor has two systems of switching brushes, each of the two systems being constructed by a positive-electrode switching brush and a negative-electrode switching brush, and that, when an electricity-feeding line used for electricity-feeding to one system of the two systems of switching brushes has broken, the valve timing control device is configured to stop energization to the other system or reduce an energization amount to the other system, after having energized the other system of switching brushes until such time that a predetermined time has expired from a start of the engine.

### Advantageous Effects of Invention

According to the present invention, even when a portion of an electricity-feeding line of an electric motor, included in one of two systems, has broken, the valve timing control device can be operated by energizing the other system of switching brushes.

### BRIEF DESCRIPTION OF DRAWINGS

FIG. 1 is a longitudinal cross-sectional view illustrating an embodiment of a valve timing control device according to the invention.

FIG. 2 is a disassembled perspective view illustrating the essential component parts of the embodiment.

FIG. 3 is a cross-sectional view taken along the line A-A of FIG. 1.

FIG. 4 is a cross-sectional view taken along the line B-B of FIG. 1.

FIG. 5 is a cross-sectional view taken along the line C-C of FIG. 1.

FIG. 6 is a schematic view illustrating an electric motor of the embodiment and the configuration for energizing the electric motor.

FIG. 7 is a control flowchart of the first embodiment of a control unit.

FIG. 8 is a control flowchart of the second embodiment of a control unit.

FIG. 9 is a control flowchart of the third embodiment of a control unit.

FIG. 10 is a control flowchart of the fourth embodiment of a control unit.

FIG. 11 is a control flowchart of the fifth embodiment of a control unit.

### DESCRIPTION OF EMBODIMENTS

Respective embodiments of a valve timing control device for an internal combustion engine and a controller for the valve timing control device according to the invention are hereinafter described in detail with reference to the drawings.

### First Embodiment

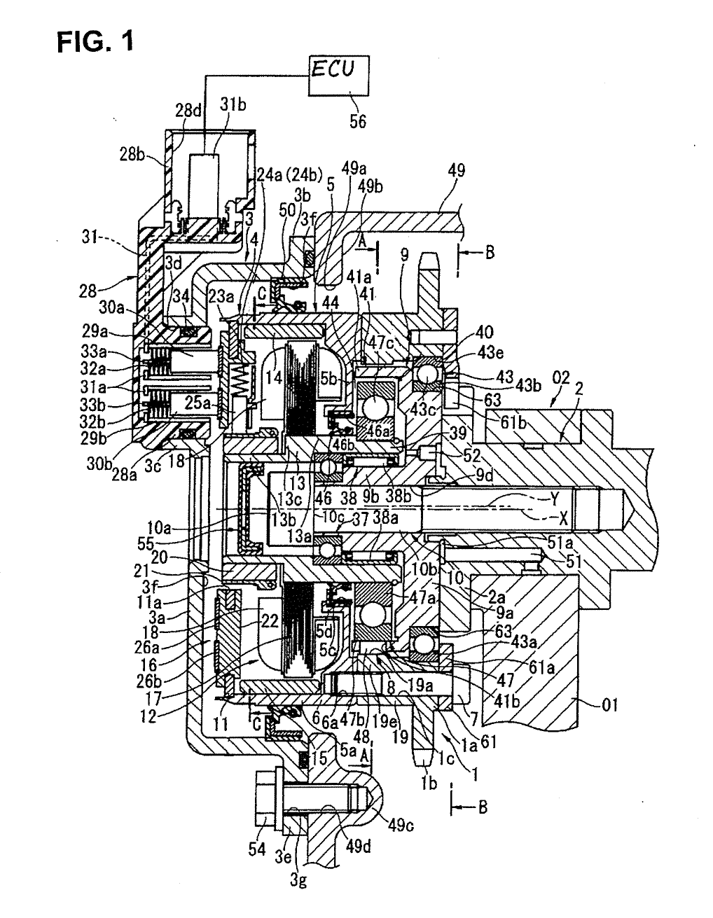

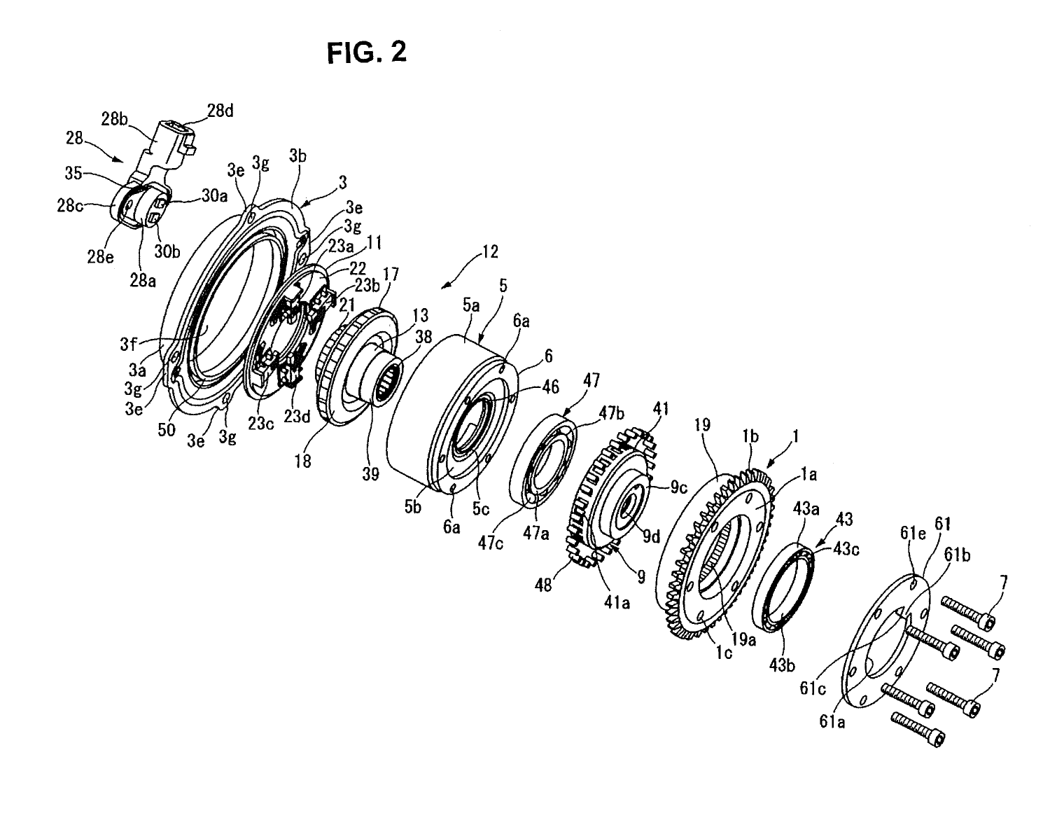

As shown in FIGS. 1-2, the valve timing control device of the embodiment is equipped with a timing sprocket 1 serving as a driving rotary member (a driving rotor) rotationally driven by a crankshaft of the internal combustion engine, a camshaft 2 rotatably supported on a cylinder head 01 via a journal bearing 02 and rotated by a rotational force transmitted from the timing sprocket 1, a phase conversion mechanism, simply, a phase converter 4 covered by a cover member 3 fixedly connected to a chain cover 49 and configured to convert or change a relative rotational phase of the camshaft 2 to the timing sprocket 1 depending on an engine operating condition.

Timing sprocket 1 is formed into a substantially annular shape and made from iron-based metal material. The timing sprocket is comprised of a sprocket body 1a formed with a stepped inner peripheral portion, a gear 1b formed integral with the outer periphery of sprocket body 1a and configured to receive a rotational force from the crankshaft through a wrapped timing chain (not shown), and an internal-tooth structural portion 19 integrally formed on the front end side of the timing sprocket.

Also, timing sprocket 1 is rotatably supported by a large-diameter ball bearing 43 interleaved between the sprocket body 1a and a driven rotary member, simply, a driven member 9 (described later) fixedly connected to the front end of camshaft 2, so as to permit rotary motion of camshaft 2 relative to timing sprocket 1.

Large-diameter ball bearing 43 is comprised of an outer ring 43a, an inner ring 43b, and balls 43c confined between outer and inner rings 43a-43b. The outer ring 43a is fixed to the inner periphery of sprocket body 1a, whereas the inner ring 43b is fixed to the outer periphery of driven member 9 (described later).

Sprocket body 1a has an annularly-grooved outer-ring retaining portion 40 formed and cut in its inner peripheral surface and configured to open toward the camshaft 2.

Outer-ring retaining portion 40 is formed as a shouldered annular groove into which the outer ring 43a of large-diameter ball bearing 43 is axially press-fitted. The shouldered portion of outer-ring retaining portion 40 serves to position one axial end face of the outer ring 43a in place.

Internal-tooth structural portion 19 is formed integral with the front end of sprocket body 1a, and formed into a comparatively thick-walled, cylindrical shape extended toward an electric motor 12 (described later) of phase converter 4. The internal-tooth structural portion is formed on its inner periphery with a plurality of waveform internal teeth 19a.

The rear end side of an annular female screw-threaded portion 6, formed integral with a housing 5 (described later), and the front end side of internal-tooth structural portion 19 are arranged to be axially opposed to each other.

An annular retainer plate 61 is located at the rear end of sprocket body 1a, facing apart from the internal-tooth structural portion 19. Retainer plate 61 is made from a metal plate. As shown in FIG. 1, the outside diameter of retainer plate 61 is dimensioned to be approximately equal to that of the sprocket body 1a. The inner peripheral portion 61a of retainer plate 61 is kept in abutted-engagement with the outside end face (the rearward end face) 43e of the outer ring 43a with a slight push from the inside face of the retainer plate for positioning. Also, the inner peripheral portion 61a of the annular retainer plate has a radially-inward protruding stopper 61b integrally formed at a given circumferential angular position of the inner peripheral portion 61a, and configured to protrude toward the central axis of the retainer plate.

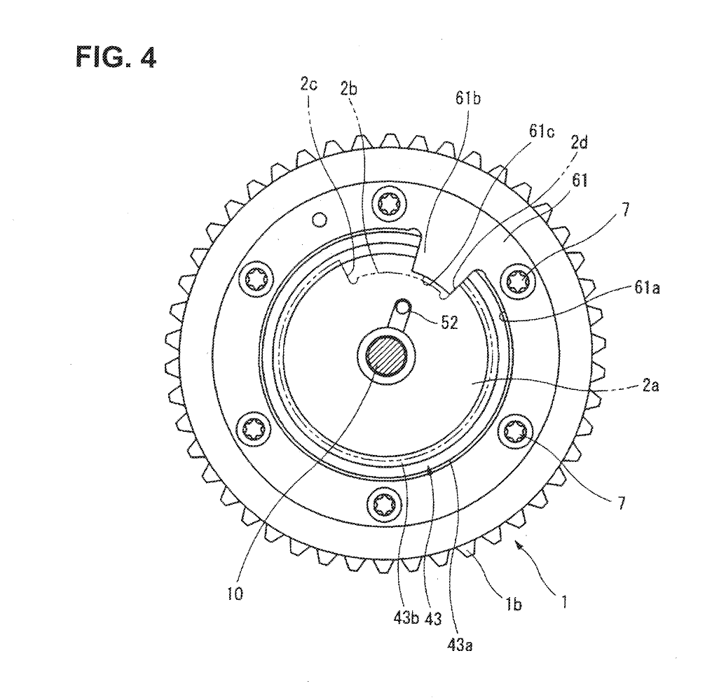

As shown in FIGS. 1 and 4, the protruding stopper 61b is formed into a substantially sector. The innermost edge 61c of stopper 61b is configured to be substantially conformable to a shape of the circular-arc peripheral surface of a stopper groove 2b (described later) of the camshaft front end. The outer peripheral portion of retainer plate 61 is formed with circumferentially equidistant-spaced, six bolt insertion holes 61e (through holes) through which bolts 7 are inserted.

In a similar manner to the six bolt insertion holes 61e (through holes) formed in the retainer plate 61, the outer peripheral portion of sprocket body 1a (internal-tooth structural portion 19) is formed with circumferentially equidistant-spaced, six bolt insertion holes 1c (through holes). Also, the female screw-threaded portion 6 is formed with six female screw threads 6a configured to be conformable to respective circumferential positions of bolt insertion holes 1c (bolt insertion holes 61e). Hence, the timing sprocket 1, the retainer plate 61, and the housing 5 (the female screw-threaded portion), are integrally connected to each other by axially fastening them together with six bolts 7 inserted.

By the way, the sprocket body 1a and the internal-tooth structural portion 19 are structured as a casing for a speed reducer 8 (described later).

Also, the respective outside diameters of sprocket body 1a, internal-tooth structural portion 19, retainer plate 61, and female screw-threaded portion 6 are set or dimensioned to be approximately equal to each other.

As shown in FIG. 1, chain cover 49 is laid out and bolted onto the front end side of a cylinder block (not shown) and cylinder head 01 in a manner so as to vertically extend for covering the timing chain (not shown) wound on the timing sprocket 1. Chain cover 49 has an opening 49a configured to be conformable to the contour of phase converter 4. Also, four boss sections 49c are integrally formed at four circumferential angular positions of an annular wall 49b constructing the opening 49a. Also, four female screw-threads 49d are machined in respective boss sections 49c such that female screw-threads 49d extend from the front end face of the annular wall 49b into the respective boss sections 49c.

As shown in FIGS. 1-2, cover member 3 is made from aluminum alloy and formed into a substantially cup shape. The cover member 3 is comprised of a cup-shaped cover main body 3a and an annular mounting flange 3b formed integral with the circumference of the right-hand side opening end of cover main body 3a. Cover main body 3a is configured to cover the front end of housing 5. Cover main body 3a has a slightly axially-extending cylindrical wall portion 3c integrally formed at a given position deviated radially upward from the center of the cover main body. The cylindrical wall portion 3c has a retaining through-hole 3d formed therein for retaining a brush retainer 28 or a connector retainer (described later).

Mounting flange 3b is integrally formed with circumferentially equidistant-spaced, four tab-like portions 3e configured to protrude radially outward. Four bolt insertion holes 3g (through holes) are bored in respective tab-like portions 3e of the mounting flange. Cover member 3 is fixedly connected to the chain cover 49 by means of bolts 54, which are inserted through the respective bolt insertion holes 3g and screwed into the female screw-threads formed in the respective boss sections.

As shown in FIGS. 1-2, a large-diameter oil seal 50 is interleaved between the shouldered annular groove portion 3f formed in the peripheral wall surface inside of the circumference of cover main body 3a and the outer peripheral surface of housing 5. Large-diameter oil seal 50 is formed into a substantially C-shape in lateral cross section. Oil seal 50 is made from synthetic rubber (a base material), and also a core metal is buried in the base material. The outer peripheral annular base-material wall section of oil seal 50 is fitted to the shouldered annular groove portion 3f formed in the inner peripheral wall surface of the cover main body of cover member 3 in a fluid-tight fashion. The large-diameter oil seal 50 is configured to suppress entry of lubricating oil, scattered from the rotationally driven sprocket 1, into the electric motor 12 (described later).

Housing 5 is comprised of a housing main body 5a made from iron-based metal material and formed into a substantially cylindrical shape with a bottom face by pressing, and a seal plate 11 made from synthetic resin (non-magnetic material) and provided for sealing the axially forward opening of housing main body 5a.

Housing main body 5a has a disk-shaped partition wall 5b formed at its rear end. Housing main body 5a is also formed in a substantially center of the partition wall 5b with a large-diameter eccentric-shaft insertion hole 5c into which an eccentric shaft 39 (described later) is inserted. An axially extending cylindrical portion 5d is formed integral with the annular edge of eccentric-shaft insertion hole 5c in a manner so as to protrude toward the cover member 3.

Partition wall 5b is formed as a comparatively thin-walled partition section shaped into a recessed cross section contoured to cover one axial side of coils 18 of electric motor 12 (describe later). The previously-discussed thick-walled annular female screw-threaded portion 6 is formed integral with the circumference of the front end face of partition wall 5b.

Camshaft 2 has two rotary cams integrally formed on its outer periphery for operating the associated two intake valves (not shown) per one engine cylinder. Also, camshaft 2 has a flanged portion 2a integrally formed at its front end. By the way, the rotary cam is formed into a conventional oval shape and configured to operate (open) the associated intake valve against the spring force of a valve spring via a valve lifter.

As shown in FIG. 1, the outside diameter of flanged portion 2a is dimensioned to be slightly greater than that of the fixed-end portion 9a of a driven member 9 (described later). Hence, after installation of all component parts, the circumference of the front end face of the flanged portion 2a of camshaft 2 is brought into abutted-engagement with the rearward end face (the axially outside end face) of the inner ring 43b of large-diameter ball bearing 43. Under a state where the front end face of flanged portion 2a has been brought into axially abutted-engagement with the driven member 9, the driven member and the camshaft flanged portion are axially connected to each other by means of a cam bolt 10.

As shown in FIG. 4, the outer periphery of flanged portion 2a is partially cut or machined as the stopper groove 2b recessed along the circumferential direction. The stopper recessed groove 2b is brought into engagement with the protruding stopper 61b of retainer plate 61. The stopper recessed groove 2b is formed into a circular-arc shape having a specified circumferential length to permit a circumferential movement of the protruding stopper 61b within a limited motion range determined based on the specified circumferential length. Hence, a maximum phase-advance position of camshaft 2 relative to timing sprocket 1 is restricted by abutment between the counterclockwise edge of protruding stopper 61b and the clockwise edge 2c of stopper groove 2b. On the other hand, a maximum phase-retard position of camshaft 2 relative to timing sprocket 1 is restricted by abutment between the clockwise edge of protruding stopper 61b and the counterclockwise edge 2d of stopper groove 2b.

By the way, protruding stopper 61b is somewhat bent and displaced toward the side of rotary cams of camshaft 2 with respect to the inner peripheral portion 61a, which is kept in abutted-engagement with the outside end face (the rearward end face) of the outer ring 43a of large-diameter ball bearing 43 with a slight push. Thus, the protruding stopper is kept in a spaced, contact-free relationship with the fixed-end portion 9a of driven member 9, thereby suppressing undesirable interference between the protruding stopper 61b and the fixed-end portion 9a.

In this manner, a stopper mechanism is constructed by the protruding stopper 61b and the stopper groove 2b.

As shown in FIG. 1, cam bolt 10 is comprised of a head 10a and a shank 10b formed integral with each other. The end face 10c of head 10a, facing the shank 10b, is kept in abutted-engagement with the inner ring of a small-diameter ball bearing 37 (described later) in the axial direction. The cam bolt has a male screw-threaded portion formed on the outer periphery of the top end side of shank 10b and configured to be screwed into a female screw-threaded portion machined into the front end of camshaft 2 along the axis of camshaft 2.

Driven member 9 is made from iron-based metal material. As shown in FIG. 1, the driven member 9 is comprised of the disk-shaped fixed-end portion 9a, an axially-forward-extending cylindrical portion 9b formed integral with the front end face of disk-shaped fixed-end portion 9a, and a substantially cylindrical cage 41, which cage is formed integral with the outer periphery of the fixed-end portion 9a and configured to serve as a roller holder for holding a plurality of rollers 48 (rolling elements).

The rear end face of fixed-end portion 9a is arranged to abut with the front end face of the flanged portion 2a of camshaft 2, and fixedly connected to the flanged portion 2a by an axial force of cam bolt 10.

The previously-noted cylindrical portion 9b is formed with a central bore 9d into which the shank 10b of cam bolt 10 is inserted. A needle bearing 38 is mounted on the outer periphery of cylindrical portion 9b.

As shown in FIGS. 1-3, cage 41 (the roller holder) is configured to further extend from the front end of the outer periphery of fixed-end portion 9a, and bent into a substantially C shape in longitudinal cross section and formed into a substantially cylindrical shape extending in the same axial direction as the cylindrical portion 9b and having an annular bottom. The substantially cylindrical end portion 41a of cage 41 is configured to extend toward the partition wall 5b of housing 5 through an annular internal space 44 defined between the female screw-threaded portion 6 and the axially extending cylindrical portion 5d. Also, the substantially cylindrical end portion 41a has a plurality of substantially rectangular roller-holding holes 41b (the roller-holding portions), which is configured to be equidistant-spaced from each other with a given circumferential interval in the circumferential direction of the substantially cylindrical end portion. The plurality of rollers 48 are rotatably held or retained in the respective roller-holding holes. The roller holder is configured to have one fewer roller-holding holes 41b (in other words, one fewer rollers 48) than the number of internal teeth 19a of internal-tooth structural portion 19.

An inner-ring retaining portion 63 is cut or machined and defined between the outer periphery of fixed-end portion 9a and the annular bottom of cage 41 formed integral with each other, for retaining the inner ring 43b of large-diameter ball bearing 43.

Inner-ring retaining portion 63 is formed as a shouldered annular groove machined or cut to be radially opposed to the outer-ring retaining portion 40. Inner-ring retaining portion 63 is comprised of a cylindrical outer peripheral surface extending in the axial direction of camshaft 2 and another radially-extending, retaining shouldered surface configured to be continuous with the cylindrical outer peripheral surface and formed on the side being opposite to the opening end of the cylindrical outer peripheral surface. When assembling, the inner ring 43b of large-diameter ball bearing 43 is axially press-fitted onto the cylindrical outer peripheral surface. At the same time, the innermost end face (the forward end face) of the press-fitted inner ring 43b is brought into abutted-engagement with the another shouldered surface of the inner-ring retaining portion, to axially position the press-fitted inner ring in place.

Phase converter 4 is mainly constructed by the electric motor 12 coaxially located at the front end of camshaft 2, and the speed reducer 8 provided for reducing the rotational speed of electric motor 12 and for transmitting the reduced motor speed to the camshaft 2.

As shown in FIGS. 1-2, electric motor 12 is a brush-equipped direct-current (DC) motor. Electric motor 12 is comprised of the housing main body 5a serving as a yoke that rotates together with the timing sprocket 1, the motor output shaft 13 rotatably installed in the housing main body 5a, a pair of substantially semi-circular permanent magnets 14, 15 fixedly connected onto the inner peripheral surface of housing main body 5a, a stator 16 fixed to the seal plate 11, and an iron-core rotor 17 having a plurality of magnetic poles and installed onto the outer periphery of motor output shaft 13.

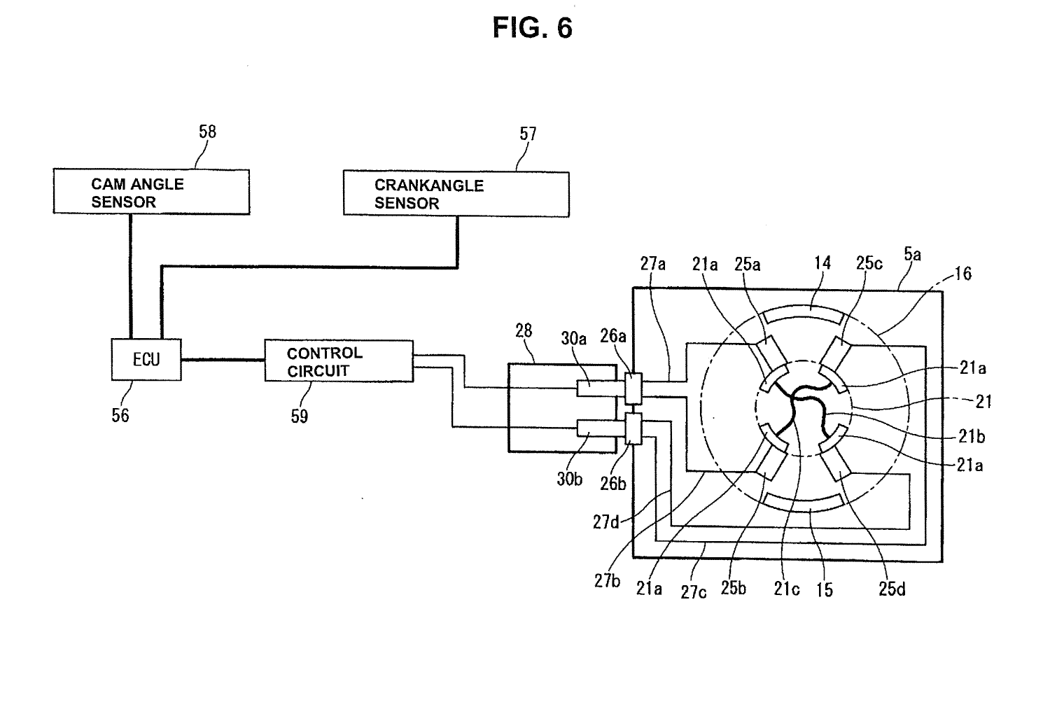

As shown in FIG. 6, a current path for electric-current supply to the electric motor 12 is divided into two systems, that is, one being an electricity-feeding brush 30a (on the positive-electrode side) and an electricity-feeding slip ring 26a (on the positive-electrode side), and the other being an electricity-feeding brush 30b (on the negative-electrode side) and an electricity-feeding slip ring 26b (on the negative-electrode side). Of four pigtail harnesses in total, two pigtail harnesses 27a, 27b (on the positive-electrode side) are configured to extend from the electricity-feeding slip ring 26a, whereas two pigtail harnesses 27c, 27d (on the negative-electrode side) are configured to extend from the electricity-feeding slip ring 26b. That is, one end of each of two positive-electrode pigtail harnesses is connected to the positive-electrode electricity-feeding slip ring 26a, whereas one end of each of the negative-electrode pigtail harness is connected to the negative-electrode electricity-feeding slip ring 26b. The other end of the positive-electrode pigtail harness 27a is connected to a switching brush 25a (on the positive-electrode side), whereas the other end of the positive-electrode pigtail harness 27b is connected to a switching brush 25b (on the positive-electrode side). In a similar manner, the other end of the negative-electrode pigtail harness 27c is connected to a switching brush 25c (on the negative-electrode side), whereas the other end of the negative electrode pigtail harness 27d is connected to a switching brush 25d (on the negative-electrode side).

As shown in FIG. 1, motor output shaft 13 is formed into a shouldered cylindrical hollow shape, and serves as an armature. Motor output shaft 13 is constructed by a large diameter portion 13a on the side of camshaft 2 and a small diameter portion 13b on the side of brush retainer 28 through a shouldered portion 130 formed substantially at midpoint of the axially-extending cylindrical-hollow motor output shaft.

The previously-discussed iron-core rotor 17 is fixedly connected onto the outer periphery of large-diameter portion 13a. Eccentric shaft 39 is axially press-fitted into and integrally connected to the top end of large-diameter portion 13a.

An annular member 20 is press-fitted onto the outer periphery of small-diameter portion 13b. A commutator 21 is axially press-fitted onto the outer peripheral surface of annular member 20, in a manner so as to be axially positioned in place by the axial end face of shouldered portion 13c. The outside diameter of annular member 20 is dimensioned to be approximately equal to that of large-diameter portion 13a. The axial length of annular member 20 is dimensioned to be slightly shorter than that of small-diameter portion 13b.

Furthermore, plug 55 is fixed or press fitted to the inner peripheral surface of small-diameter portion 13b, for suppressing undesirable leakage of lubricating oil, which oil is supplied into the motor output shaft 13 and eccentric shaft 39 for lubrication of the previously-discussed ball bearing 37 and needle bearing 38, into the electric motor 12.

Iron-core rotor 17 is formed by a magnetic material having a plurality of magnetic poles. The outer periphery of iron-core rotor 17 is constructed as a bobbin having slots on which the winding of each of coils 18 is wound.

As shown in FIG. 6, commutator 21 is formed as a substantially annular shape and made from a conductive material. Commutator 21 is divided into a plurality of segments 21a whose number is equal to the number of magnetic poles of iron-core rotor 17. Terminals of the coil winding (not shown) drawn out from coil 18 are electrically connected to each of these segments 21a of the commutator. That is, the terminals of the coil winding are sandwiched and electrically connected to the hemmed section formed on the periphery of commutator 21. A first positive-electrode segment of the positive-electrode segments 21a and a first negative-electrode segment of the negative-electrode segments 21a are electrically connected to each other by a magnet harness 21b. Also, a second positive-electrode segment of the positive-electrode segments 21a and a second negative-electrode segment of the negative-electrode segments 21a are electrically connected to each other by a magnet harness 21c.

As a whole, the previously-discussed permanent magnets 14, 15 are formed into a cylindrical shape, and have a plurality of magnetic poles in the circumferential direction. The axial position of each of permanent magnets 14, 15 is offset forward from the fixed position of iron-core rotor 17. Hence, the front ends of permanent magnets 14, 15 are arranged to overlap with switching brushes 25a, 25b, 25c, and 25d (described later) for commutator 21 and stator 16 in the radial direction.

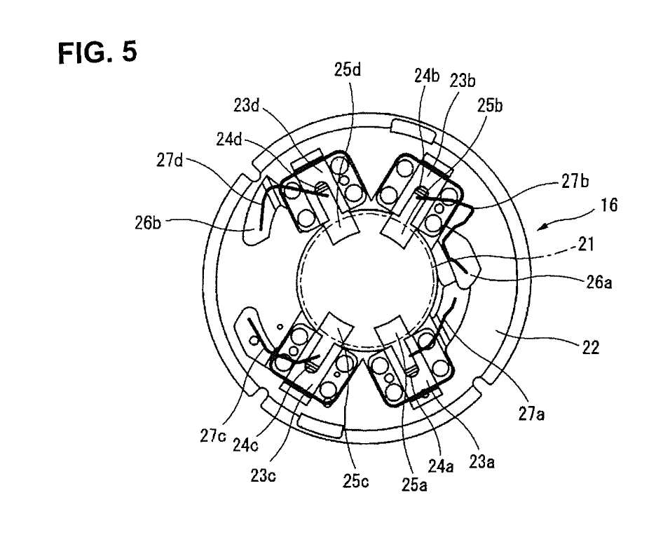

As shown in FIGS. 5-6, stator 16 is mainly comprised of a disk-shaped synthetic-resin plate 22, four metal brush holders 23a, 23b, 23c, and 23d, the previously-discussed four switching brushes 25a, 25b, 25c, and 25d, the annular electricity-feeding slip rings 26a, 26b, and pigtail harnesses 27a, 27b, 27c, and 27d. The disk-shaped synthetic-resin plate 22 is integrally connected to the inner periphery of seal plate 11. Four metal brush holders 23a, 23b, 23c, and 23d are attached onto the inside face of synthetic-resin plate 22. Four switching brushes 25a, 25b, 25c, and 25d are accommodated and held in respective brush holders 23a-23d so as to be radially slidable. The radially-inward ends of these four switching brushes are kept in sliding-contact (elastic-contact or electric-contact) with the outer peripheral surface of commutator 21 by respective spring forces of coil springs 24a, 24b, 24c, and 24d. The radially-inside electricity-feeding slip ring 26a and the radially-outside electricity-feeding slip ring 26b are attached to the synthetic-resin plate 22, such that the outside face of each of electricity-feeding slip rings 26a, 26b is partially exposed and that the inside face of each of slip rings 26a, 26b is buried in the front end face of synthetic-resin plate 22. The radially-inside annular slip ring 26a and the radially-outside annular slip ring 26b are laid out to be coaxial with each other. The positive-electrode electricity-feeding slip ring 26a and the switching brush 25a are electrically connected to each other via the pigtail harness 27a. The positive-electrode electricity-feeding slip ring 26a and the switching brush 25b are electrically connected to each other via the pigtail harness 27b. The negative-electrode electricity-feeding slip ring 26b and the switching brush 25c are electrically connected to each other via the pigtail harness 27c. The negative-electrode electricity-feeding slip ring 26b and the switching brush 25d are electrically connected to each other via the pigtail harness 27d.

The positive-electrode switching brush 25a and the negative-electrode switching brush 25d are laid out to be spaced apart from each other by 180° in the circumferential direction. In a similar manner, the positive-electrode switching brush 25b and the negative-electrode switching brush 25c are laid out to be spaced apart from each other by 180° in the circumferential direction.

The previously-discussed electricity-feeding slip rings 26a, 26b construct part of an electricity-feeding mechanism. The previously-discussed switching brushes 25a-25d, and commutator 21, and pigtail harnesses 27a-27d are constructed as an energization switching mechanism.

The previously-discussed seal plate 11 is fitted into a recessed, shouldered portion formed or cut in the inner periphery of the front end of housing 5, and fixedly connected to the front end of the housing in place by caulking. Also, the subassembly of the seal plate and the disk-shaped synthetic-resin plate is formed in its center with a shaft insertion hole 11a (a through hole) into which one axial end of motor output shaft 13 is inserted.

The brush retainer 28, which is integrally molded of a synthetic resin material and constructs part of the electricity-feeding mechanism, is fixedly connected to the cover main body 3a. As shown in FIG. 1, brush retainer 28 is formed into a substantially L shape in side view. Brush retainer 28 is comprised of a substantially cylindrical brush-retaining portion 28a, a connector portion 28b, a pair of laterally-extending tab-like brackets 28c, 28c, and a pair of terminal strips 31, 31. Brush-retaining portion 28a is inserted into the retaining through-hole 3c. Connector portion 28b is formed integral with the upper end of brush-retaining portion 28a. Brackets 28c, 28c are formed integral with both sides of brush-retaining portion 28a and fixedly connected to the cover main body 3a. Most of terminal strips 31, 31 are buried in the synthetic-resin brush retainer 28.

Terminal strips 31, 31 are arranged parallel with each other so as to extend vertically and partly cranked. One end (the downward terminal 31a) of each of these crank-shaped terminal strips is exposed to the bottom of brush-retaining portion 28a. The other end (the upward terminal 31b) of each of the two terminal strips is configured to protrude into a female fitting groove 28d of connector portion 28b. The upward terminals 31a, 31b of the two terminal strips are electrically connected to a battery power source (not shown) via a male socket (not shown).

Brush-retaining portion 28a is configured to extend horizontally (axially). An upper hollow sleeve 29b is fixed or press-fitted into an upper cylindrical-hollow through hole bored in the brush-retaining portion. In a similar manner, a lower hollow sleeve 29a is fixed or press-fitted into a lower cylindrical-hollow through hole bored in the brush-retaining portion. Electricity-feeding brushes 30a, 30b are supported in the respective hollow sleeves 29a, 29b so as to be axially slidable. The tips of electricity-feeding brushes 30a, 30b are kept in sliding-contact (abutted-engagement or electric-contact) with respective slip rings 26a and 26b.

Each of electricity-feeding brushes 30a, 30b is formed into a substantially rectangular parallelopiped shape. A second coil spring 32a is disposed between the downward terminal 31a exposed to the bottom of the upper cylindrical hollow through hole of the brush-retaining portion and the associated electricity-feeding brush under preload. In a similar manner, a second coil spring 32b is disposed between the downward terminal 31a exposed to the bottom of the lower cylindrical-hollow through hole of the brush-retaining portion and the associated electricity-feeding brush under preload. Thus, the tips of electricity-feeding brushes 30a, 30b are permanently forced or biased toward respective slip rings 26a and 26b by the spring forces of second coil springs 32a, 32b, so as to bring the tips of electricity-feeding brushes 30a, 30b into elastic-contact with the respective end faces of the slip rings.

Additionally, a flexible pigtail harness 33a is connected between the rear end of electricity-feeding brush 30a and the downward terminal 31a exposed to the bottom of the upper cylindrical-hollow through hole, to provide electric connection between them. In a similar manner, flexible pigtail harness 33b is electrically connected between the rear end of electricity-feeding brush 30b and the downward terminal 31a exposed to the bottom of the lower cylindrical-hollow through hole, to provide electric connection between them. The lengths of pigtail harnesses 33a, 33b are set to appropriate lengths sufficient to restrict maximum sliding movements (maximum axially-extended positions) of electricity-feeding brushes 30a, 30b relative to sleeves 29a, 29b for preventing the electricity-feeding brushes 30a, 30b from falling out of the respective sleeves 29a, 29b by the spring forces of coil springs 32a, 32b.

An annular seal member 34 is fitted and retained in an annular groove formed in the outer periphery of the root (the basal end) of brush-retaining portion 28a.

As previously-discussed, the connector portion 28b is formed at its upper end with the female fitting groove 28d into which the male socket (not shown) is inserted. The upward terminals 31b, 31b, configured to protrude into the female fitting groove 28d, are electrically connected to a control unit 56 (serving as a controller) via the male socket.

As seen in FIG. 2, each of the laterally-extending diametrically-opposed brackets 28c, 28c is formed into a substantially U shape. The bracket pair has bolt insertion holes (through hole) 28e, 28e formed on both sides. Thus, brush retainer 28 is fixedly connected to the cover main body 3a by means of bolts, which are inserted through the respective bolt insertion holes 28e, 28e of the brackets and screwed into respective female screw-threads (not shown) formed in the cover main body 3a.

The previously-discussed motor output shaft 13 and eccentric shaft 39 are rotatably supported by means of the small-diameter ball bearing 37 and the needle bearing 38. Small-diameter ball bearing 37 is installed on the outer peripheral surface of the root of the shank 10b near the head 10a of cam bolt 10. On the other hand, needle bearing 38 is mounted on the outer peripheral surface of cylindrical portion 9b of driven member 9, and arranged in close proximity to the right-hand side end of small-diameter ball bearing 37 such that these bearings are juxtaposed to each other.

Needle bearing 38 is comprised of a cylindrical retainer 38a press-fitted into the inner peripheral surface of eccentric shaft 39 and a plurality of needle rollers 38b (rolling elements) rotatably retained inside of the retainer 38a. One axial end of retainer 38a, facing the outer ring of small-diameter ball bearing 37, is kept in abutted-engagement with the sidewall of the outer ring. On the other hand, each of needle rollers 38b is in rolling-contact with the outer peripheral surface of cylindrical portion 9b of driven member 9.

A small-diameter oil seal 46 is interleaved between the outer peripheral surface of motor output shaft 13 (eccentric shaft 39) and the inner peripheral surface of axially extending cylindrical portion 5d of housing 5, for preventing leakage of lubricating oil from the inside of speed reducer 8 toward the inside of electric motor 12. Small-diameter oil seal 46 is constructed by a basal part 46a fixed to the inner periphery of axially-extending cylindrical portion 5d, a seal part 46b which is integrally connected to the inner periphery of the basal part 46a and whose inner periphery is sliding-contact with the outer peripheral surface of large-diameter portion 13a of motor output shaft 13, and a backup spring configured to bias the seal part 46b toward the outer peripheral surface of large-diameter portion 13a.

As shown in FIG. 6, the previously-discussed control unit 56 receives input informational signals from various sensors, namely, a crank angle sensor 57, an airflow meter, a water temperature sensor (an engine coolant temperature sensor), an engine oil temperature sensor, an accelerator opening sensor, and the like, so as to detect latest up-to-date informational data (the current engine operating condition), for engine control. The crank angle sensor 57 is provided to detect a rotational angle of the crankshaft. The airflow meter is provided to detect an intake air amount of the engine. The water temperature sensor is provided to detect an engine coolant temperature. The engine oil temperature sensor is provided to detect an oil temperature of the engine. Also, the control unit is configured to output a control current to each of coils 18 via the connector terminals 31b, and electricity-feeding brushes 30a, 30b, for rotation control of motor output shaft 13.

Control unit 56 is also configured to receive informational signals from the crank angle sensor 57 and a cam angle sensor 58 that detects a rotational angle of camshaft 2, for monitoring or detecting latest up-to-date information about the current relative rotational position of camshaft 2 to the crankshaft and for outputting a signal indicative of the current actual relative rotational position to a control circuit 59. The control circuit 59 constructs part of the control unit 56. The control circuit is configured to calculate a target phase conversion angle based on the detected signals from crank angle sensor 57 and cam angle sensor 58, and energize the electricity-feeding brushes 30a, 30b via the connector retainer 28, for driving the electric motor 12 so as to achieve the target phase conversion angle.

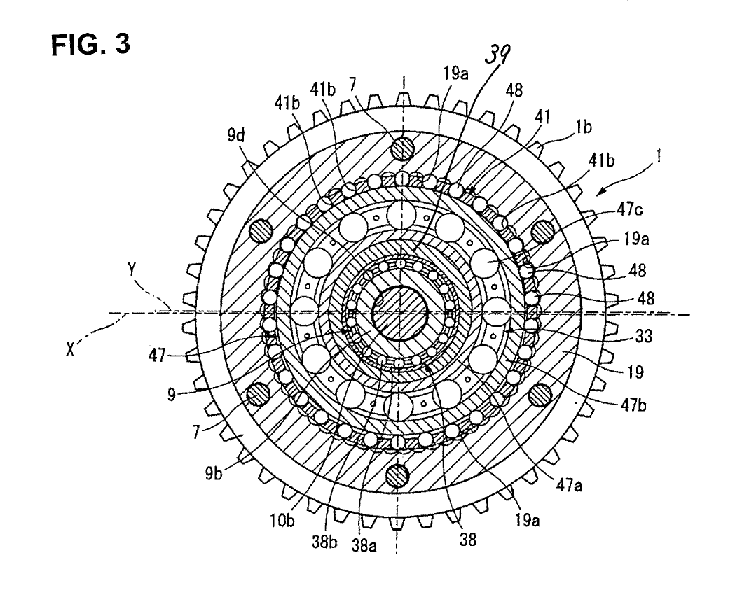

As shown in FIGS. 1 and 3, speed reducer 8 is mainly comprised of the eccentric shaft 39 that performs eccentric rotary motion, a middle-diameter ball bearing 47 installed on the outer periphery of eccentric shaft 39, rollers 48 rotatably installed on the outer periphery of middle-diameter ball bearing 47, cage 41 configured to retain and guide these rollers 48 in the direction of rolling movement of these rollers, while permitting a slight radial displacement (a slight oscillating motion) of each of rollers 48, and the driven member 9 formed integral with the cage 41. An eccentric-cam mechanism is constructed by the eccentric shaft 39 and the middle-diameter ball bearing 47.

Eccentric shaft 39 is formed into a shouldered cylindrical-hollow shape. The front end side of eccentric shaft 39 is axially press-fitted into and integrally connected to the large-diameter portion 13a of motor output shaft 13. The geometric center “Y” of the cam contour surface 39a, formed on the outer periphery of the eccentric shaft, is slightly displaced from the axis “X” of motor output shaft 13 in the radial direction.

Most of middle-diameter ball bearing 47 is arranged to radially overlap with the needle bearing 38. Middle-diameter ball bearing 47 is comprised of an inner ring 47a, an outer ring 47b, and balls 47c rotatably disposed and confined between them. The inner ring 47a is press-fitted onto the eccentric-cam contour surface 39a of eccentric shaft 39. In contrast to the inner ring, the outer ring 47b is not securely fixed in the axial direction, such that the outer ring is free and therefore is able to move contact-free. That is, one sidewall of the outer ring 47b, facing the side of electric motor 12, is kept out of contact with any part of the motor housing, while the other sidewall of the outer ring, axially opposed to the inside wall surface of cage 41, is kept out of contact with the inside wall surface. Concretely, a very small axial clearance is defined between the other sidewall of the outer ring 47b and the inside wall surface of cage 41, axially opposed to each other, such that the outer ring is able to move contact-free.

Rollers 48 are held in rolling-contact with the outer peripheral surface of outer ring 47b. A crescent-shaped annular clearance is defined between the outer peripheral surface of outer ring 47b and the substantially comb-tooth shaped protruding portion of the cage. Owing to eccentric rotary motion of eccentric shaft 39, middle-diameter ball bearing 47 can be radially displaced by virtue of the crescent-shaped annular clearance.

Each of rollers 48 is made from iron-based metal material. Owing to the eccentric displacement of middle-diameter ball bearing 47, some of rollers 48 are brought into fitted-engagement into some troughs of internal teeth 19a of internal-tooth structural portion 19, while radially moving. That is, owing to the eccentric displacement of the middle-diameter ball bearing and the like, each of rollers 48 can radially oscillate, while being circumferentially guided by both inside edges of each of roller-holding holes 41b of cage 41.

Also provided is a lubricating-oil supply means for supplying lubricating oil into the internal space of speed reducer 8. The lubricating-oil supply means is comprised of an oil supply passage 42 which is formed in the journal bearing 42 of the cylinder head 01 and to which lubricating oil is supplied from a main oil gallery (not shown), an oil supply hole 51, and a small-diameter oil hole 52. As shown in FIG. 1, oil supply hole 51 is formed in the camshaft 2 so as to extend axially, and configured to communicate the oil supply passage via an oil groove. Small-diameter oil hole 52 is formed as an axially-extending through hole in the driven member 9, such that one end of small-diameter oil hole 52 is opened into the oil supply hole 51 through an annular passage 51a and the other end of small-diameter oil hole 52 is opened into the internal space defined near both the needle bearing 38 and the middle-diameter ball bearing 47.

By the previously-discussed lubricating-oil supply means, lubricating oil can be supplied into the internal space 44. Then, the lubricating oil is supplied from the internal space 44 to moving parts, namely, middle-diameter ball bearing 47 and rollers 48 for lubrication, and further flows into the eccentric shaft 39 and the internal space of motor output shaft 13, for lubrication of moving parts, such as needle bearing 38 and small-diameter ball bearing 37. By the way, undesirable leakage of lubricating oil, flown into the internal space 44, to the inside of the housing 5 can be prevented or adequately suppressed by means of the small-diameter oil seal 46.

### Operation of Embodiment

The operation of the VTC device of the embodiment is hereunder described in detail.

When the engine crankshaft rotates, timing sprocket 1 rotates in synchronism with rotation of the crankshaft through the timing chain 42. On one hand, a rotational force (torque) flows from the timing sprocket through the internal-tooth structural portion 19 and the female screw-threaded member 6 to the housing 5, and thus electric motor 12 rotate in synchronism with rotation of the housing. On the other hand, a rotational force (torque) of internal-tooth structural portion 19 is transmitted via the rollers 48, cage 41, and driven member 9 to the camshaft 2, thereby enabling the rotary cams of camshaft 2 to operate (open/close) the intake valves.

During a given engine operating condition after the engine start-up, an electric current is applied from the control unit 56 through the terminal strips 31, 31, pigtail harnesses 32a, 32b, electricity-feeding brushes 30a, 30b, and slip rings 26a, 26b to each of coils 17 of electric motor 12. Hence, motor output shaft 13 is driven. Then, the output rotation from the motor output shaft is reduced by means of the speed reducer 8, and thus the reduced motor speed (in other words, the multiplied motor torque) is transmitted to the camshaft.

That is, when eccentric shaft 39 rotates eccentrically during rotation of motor output shaft 13, each of rollers 48 moves (rolls) and relocates from one of two adjacent internal teeth 19a, 19a of internal-tooth structural portion 19 to the other with one-tooth displacement per one complete revolution of motor output shaft 13, while being radially guided by the associated roller-holding hole 41b of cage 41. By way of the repeated relocations of each of rollers 48 every revolutions of motor output shaft, these rollers move in the circumferential direction with respect to the internal-tooth structural portion, while being held in rolling-contact with the outer ring of the middle-diameter ball bearing. By means of the rolling-contact of each of rollers 48, the output rotation from motor output shaft 13 is reduced and thus the reduced speed (in other words, the multiplied torque) is transmitted to the driven member 9. By the way, the reduction ratio of this type of speed reducer can be arbitrarily set depending on the number of rollers 48.

As discussed above, by motor rotation control, camshaft 2 is rotated in a normal-rotational direction or in a reverse-rotational direction relatively to the timing sprocket 1, and thus an angular phase of camshaft 2 relative to timing sprocket 1 is changed or converted, and as a result conversion control for intake valve open timing (IVO) and intake valve closure timing (IVC) to the phase-advance side or to the phase-retard side can be achieved. As a result of this, the intake-valve open/closure timing can be converted into a maximum phase-advance side or into a maximum phase-retard side. This contributes to the improved fuel economy and enhanced engine power output.

By the way, as previously-discussed, a maximum phase-conversion position of camshaft 2 relative to timing sprocket 1 in the normal-rotational direction or in the reverse-rotational direction is restricted by abutment between the counterclockwise edge of protruding stopper 61b and the clockwise edge 2c of stopper groove 2b or abutment between the clockwise edge of protruding stopper 61b and the counterclockwise edge 2d of stopper groove 2b.

When a harness of the harnesses included in the electrical systems located downstream of the electricity-feeding slip rings 26a, 26b, for instance, either one pigtail harness of pigtail harnesses 27a-27d, has broken and thus one electrical system of these electrical systems cannot be used, an electric current is applied from the control unit 56 via the control circuit 59 to the other electrical system so as to achieve the target phase conversion angle. At this time, a decrease in rotational torque produced by electric motor 12 can be compensated for by increasing the current value of the applied electric current (i.e., the energization amount to the other electrical system). However, due to such an increase in the electric current value, the quantity of heat generated from either the magnet harness 21b or the magnet harness 21c tends to increase. Thus, the insulation coating of the electricity-feeding line may be fused and then the other electrical system may be undesirably short-circuited. As a result of this, the phase converter 4 becomes inoperable.

When restarting the engine after having stopped the engine under the previously-discussed specific situation where one pigtail harness has broken, a phase change or a phase conversion to a desired phase angle suited for start-up becomes impossible. Hence, engine start-up may become difficult.

Therefore, in the shown embodiment, the controller is configured to control the phase converter 4 in a manner so as to permit or enable the engine to be restarted without increasing a load on the other electrical system, when the control circuit 59 determines that, due to undesirable breakage of a portion of the harnesses, a decrease in rotational torque of electric motor 12 occurs and thus a degradation in the phase-change responsiveness of phase converter 4 occurs.

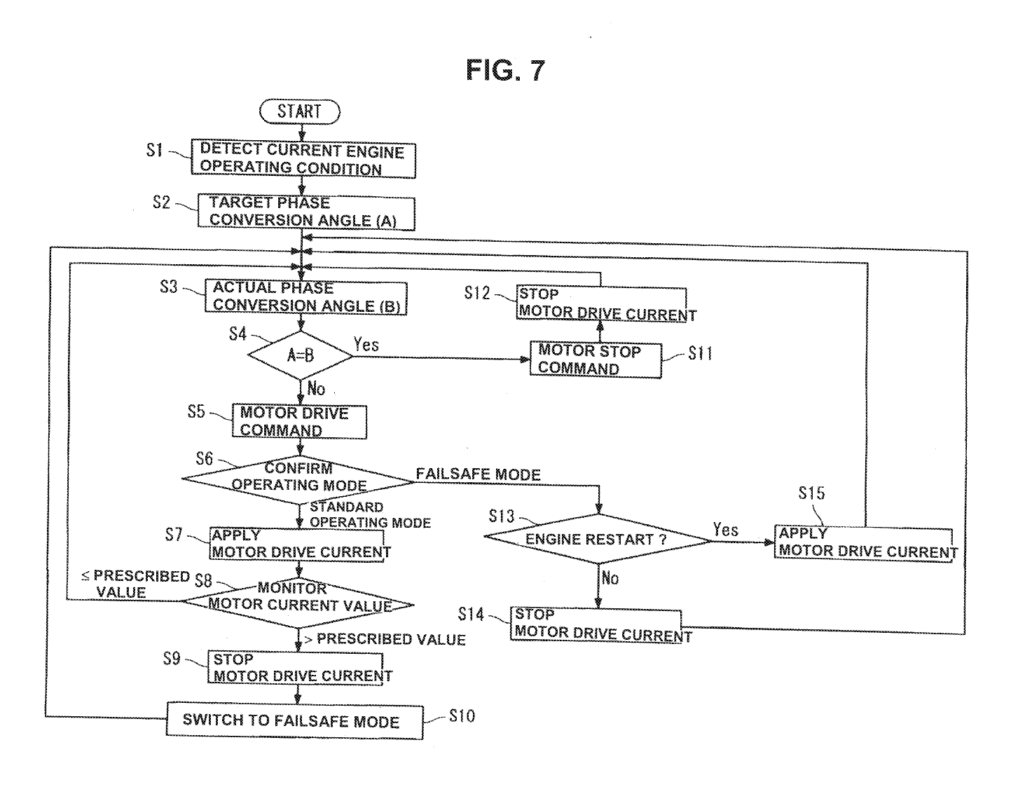

Control executed within the control circuit 59 of control unit 56 is hereunder described in detail in reference to the flowchart shown in FIG. 7.

First, the ignition switch is turned ON for starting the engine. At the same time, at step S1, informational signals from the respective sensors and the like are read for detecting the current engine operating condition.

At step S2, a target phase conversion angle (A) is calculated based on the current engine operating condition.

At step S3, the current actual phase conversion angle (B) is confirmed or determined based on informational signals outputted from the crank angle sensor 57 and the cam angle sensor 58.

At step S4, a check is made to determine whether the target phase conversion angle (A) and the actual phase conversion angle (B) are equal to each other. When it is determined, at this step, that the target phase conversion angle (A) and the actual phase conversion angle (B) are equal to each other, it is unnecessary to operate the phase converter 4. Thus, the routine proceeds to step S11 where a stop command of electric motor 12 is outputted, and then moves to step S12. At step S12, motor drive current stop processing by which a drive current supply to the motor is stopped is executed, and then the routine returns to step S3.

Conversely when it is determined, at the step S4, that the target phase conversion angle (A) and the actual phase conversion angle (B) are not equal to each other, the routine proceeds to step S5. At step S5 a motor drive command is outputted, and then the routine proceeds to step S6.

At step S6, a check is made to determine whether the operating mode of electric motor 12 is a standard mode or a failsafe mode. By the way, a decision as to whether the operating mode is a standard mode or a failsafe mode can be made based on the applied motor current value monitored via step S8 (described later). Hence, if this is the first routine (the first execution cycle), the operating mode is regarded as a standard mode, and then step S7 occurs.

At step S7, a motor drive current is applied to the electric motor 12. Thereafter, at step S8, a check is made to determine whether the applied current value is less than or equal to a prescribed value (an allowable current value). For instance, when any of pigtail harnesses 27a-27d in the two systems is not broken, thus operating in a normal energization state, the applied current value becomes less than or equal to the prescribed value, and thus it is determined that these electrical systems are operating normally. Conversely when either one of the electrical systems is broken, with the other electrical system energized, the applied electric current value tends to rise. As a result, the risen current value tends to exceed the prescribed value. In this manner, by monitoring the applied current value, a decision for the operating mode can be made.

Therefore, when step S8 determines that the applied current value is less than or equal to the prescribed value, the routine returns to step S3. Conversely when step S8 determines that the applied current value exceeds the prescribed value, the routine proceeds to step S9.

At step S9, motor drive current stop processing is executed such that the motor drive current to each of the two electrical systems is stopped. At step S10, a failsafe-mode flag is set, and then the routine returns to step S3.

By the way, at this time, assuming that the current engine temperature is greater than or equal to a prescribed temperature at which engine warm-up has been completed, the relative rotational phase of the camshaft to the crankshaft can be automatically changed to the maximum phase-retard side by an alternating torque occurring and acting on the camshaft 2 when restarting the engine. In contrast, when starting a cold engine, at the second routine (at the second execution cycle), the relative rotational phase can be changed or converted to a phase suitable for starting.

That is to say, the routine returns from step S10 to step S3, while the failsafe-mode flag remains set. Thereafter, the routine moves through steps S4, S5 to step S6. The step S6 determines that the operating mode is a failsafe mode, and thus the routine proceeds to step S13.

At step S13, a check is made to determine whether it is an engine restarting period (simply, a restart). When a restart is not determined, the routine proceeds to step S14 where motor drive current stop processing is executed such that the motor drive current is stopped. Thereafter, the routine returns to step S3. Conversely when a restart is determined, the routine proceeds to step S15.

At step S15, a motor drive current is applied to the electric motor, for changing or converting the relative rotational phase of camshaft 2 to the crankshaft to a phase suitable for starting by means of the phase converter 4 through the use of the electric motor 12. For instance, in a state where the engine is started from cold, the relative rotational phase is controlled to an intermediate rotational phase between the maximum phase-retard position and the maximum phase-advance position.

After a motor drive current has been applied at step S15, the routine returns to step S3. Thereafter, when the target phase conversion angle (A) and the actual phase conversion angle (B) become equal to each other through the use of the electric motor 12, the routine moves via step S11 to step S12, so as to stop a drive current supply to the motor.

That is, in the embodiment discussed above, even when one electrical system of the two systems has broken, electric motor 12 is energized through the use of the other electrical system when starting the engine, and thus the relative rotational phase of camshaft 2 to the crankshaft is changed or converted to a phase suitable for starting. Hence, a favorable and certain startability can be obtained. At this time, due to the broken one electrical system, almost all the electric current flows to the other electrical system, the electric current applied to the other electrical system tends to rise, as compared to a situation where the one electrical system is not broken. Hence, electric motor 12 can be driven by only the other electrical system.

Additionally to the above, immediately when the relative rotational phase has been converted to a phase suitable for starting, the electric-current supply to electric motor 12 is stopped rapidly. Therefore, it is possible to suppress an excessive energization amount to the other electrical system, thereby reducing its heating value.

### Second Embodiment

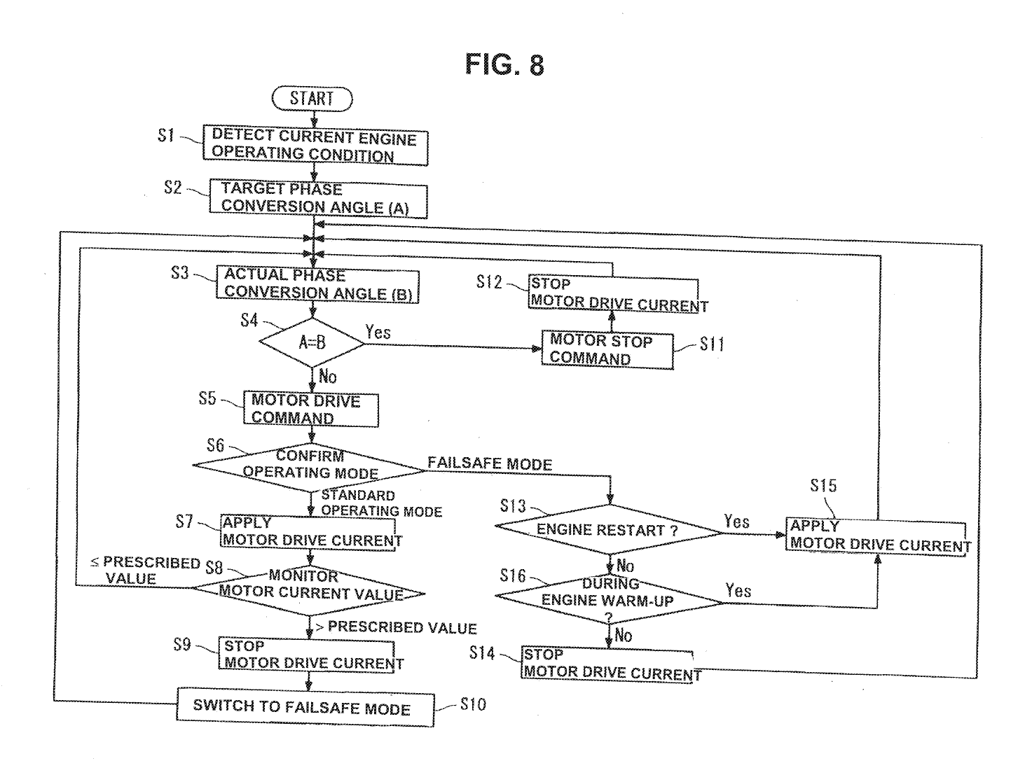

Referring to FIG. 8, there is shown the flowchart of the control flow executed within the control circuit 57 of control unit 56 in the second embodiment, whose steps S1-S13 are the same as those of the processing of FIG. 7. Thus, only the different processing step S16 will be hereinafter described in detail.

That is, when step S6 determines that the operating mode is a failsafe mode, the routine proceeds to step S13. At this step S13, a decision as to whether it is an engine restart is made. When the decision result indicates that a restart is not determined, in the second embodiment the routine proceeds to step S16.

At step S16, the current engine temperature is detected or determined based on information from the engine oil temperature sensor and the engine coolant temperature sensor, and then a check is made to determine, based on the current engine temperature, whether the engine is warming up. When it is determined that the engine is not warming up, that is, engine warm-up has already been completed, the routine proceeds to step S14. At step S14, the motor drive current is stopped. Conversely when it is determined that the engine is still warming up after starting the engine from cold, the routine proceeds to step S15 where a motor drive current is applied to the electric motor. By the way, immediately when engine warm-up has been completed after a few minutes, the routine proceeds to step S14 where the motor drive current is stopped.

When one electrical system of the two systems including pigtail harnesses 27a-27d and magnet harnesses 21b, 21c has broken, in a similar manner to the first embodiment a motor drive current can be applied or supplied for operating the phase converter 4 when restarting. Moreover, in the second embodiment, coil 18 can be energized until such time that the engine temperature, such as engine oil temperature or engine coolant temperature, reaches a prescribed reference temperature value and thus engine warmup is completed. This is because it is thought that the ambient temperatures of the coil are not very high until the engine temperature reaches the prescribed reference temperature value at which engine warmup becomes completed and hence there is no occurrence of short-circuiting caused by fusion of the insulation coating due to heat generated by magnet harnesses 21b, 21c and the like.

In this manner, by modifying the control flow in a manner so as to permit a phase-change to a target phase angle (for instance, toward the phase-advance side) suitable for idling by energizing coil 18 during cold-engine operation, it is possible to achieve both the improved fuel consumption rate and the enhanced exhaust emission control performance even when an abnormality (a failure) of electric motor 12 occurs.

The other processing steps of the control flow are the same as the first embodiment, the second embodiment can provide the same operation and effects as the first embodiment.

### Third Embodiment

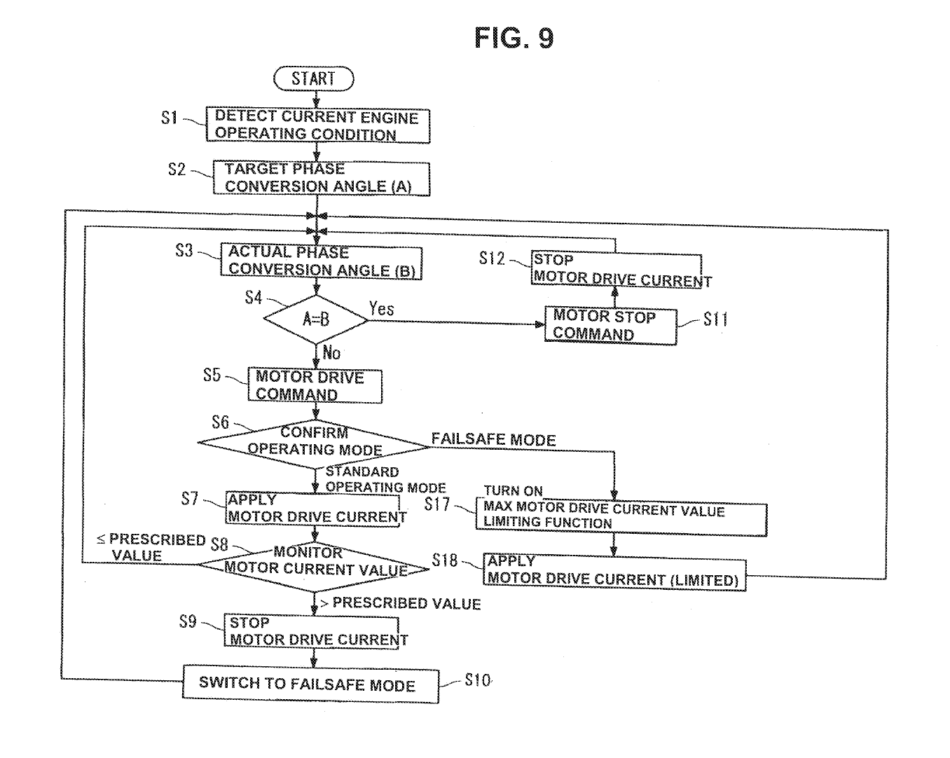

Referring to FIG. 9, there is shown the flowchart of the control flow executed within the control circuit 57 of control unit 56 in the third embodiment, whose steps S1-S12 are the same as those of the processing of FIG. 7. Thus, only the different processing steps S17, S18 will be hereinafter described in detail.

That is, when step S6 determines that the operating mode is a failsafe mode, the routine proceeds to step S17. At step S17, maximum motor drive current value limiting processing is executed such that a function for limiting the maximum current value of a motor drive current is turned ON. Thereafter, at step S18, limited motor drive current application processing is executed such that the limited motor drive current is continuously applied. For instance, as a ratio for limiting the maximum current value, the applied motor drive current is reduced to approximately 30 to 40% of the maximum current value.

In this manner, in the third embodiment, when one electrical system of the two systems including pigtail harnesses 27a-27d and magnet harnesses 21b, 21c has broken, it is possible to avoid the occurrence of undesirable short-circuiting caused by fusion of the insulation coating by limiting the maximum current value of a motor drive current applied to the other electrical system and by suppressing heat generated by magnet harnesses 21b, 21c.

As set out above, by continuously applying the limited motor drive current to the other electrical system, it is possible to permit a phase-change to a target phase angle even during normal operation of the engine as well as during an engine starting period and/or during engine warm-up. As a result of this, it is possible to achieve all the improved engine startability, the improved fuel consumption rate, and the enhanced exhaust emission control performance, and furthermore to enhance the engine output performance.

### Fourth Embodiment

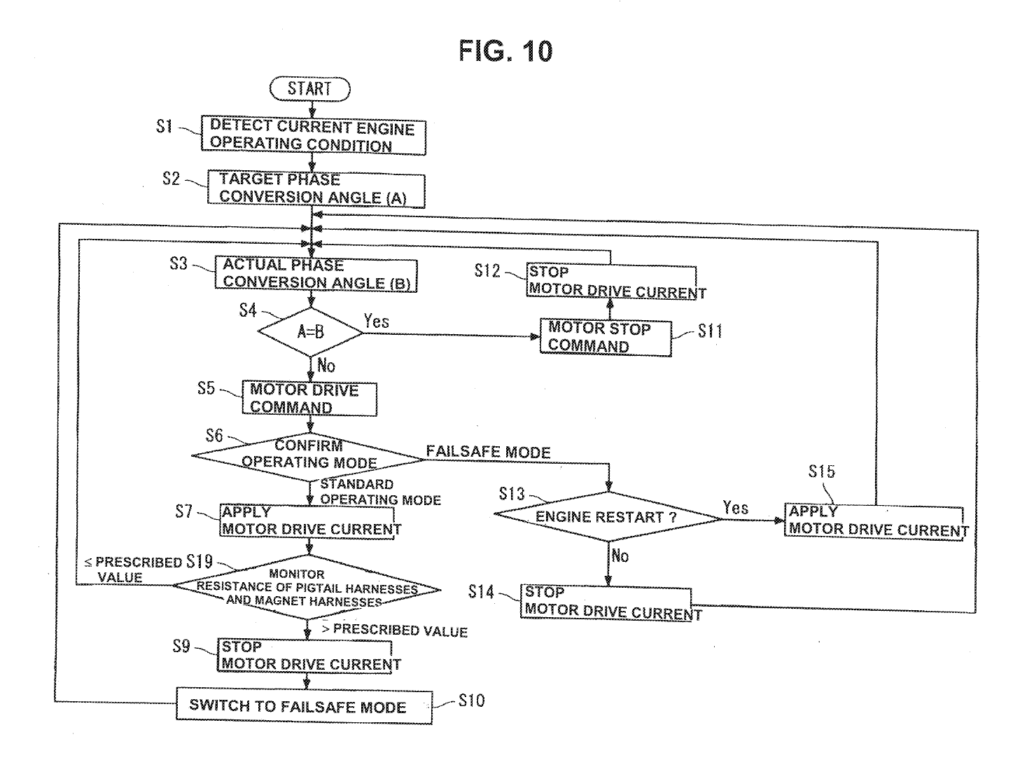

Referring to FIG. 10, there is shown the flowchart of the control flow executed within the control circuit 57 of control unit 56 in the fourth embodiment. The fourth embodiment differs from the first embodiment in that a value of electric resistance of pigtail harnesses 27a-27d and magnet harnesses 21b, 21c is monitored instead of motor current value monitoring processing executed at step S8 of FIG. 7 showing the first embodiment.

That is, at step S7, a motor drive current is applied to the electric motor 12. Thereafter, at step S19, a check is made to determine whether a value of electric resistance of pigtail harnesses 27a-27d and magnet harnesses 21b, 21c caused by application of electric current to the pigtail harnesses and the magnet harnesses is less than or equal to a prescribed value (an allowable electric resistance value). For instance, when any of pigtail harnesses 27a-27d and the like in the two systems is not broken, thus operating in a normal energization state, the monitored electric resistance value caused by application of electric current to these harnesses becomes less than or equal to the prescribed value, and thus it is determined that these electrical systems are operating normally. Conversely when either one of the electrical systems is broken, with the other electrical system energized, the electric resistance value of the pigtail harnesses and the magnet harnesses included in the other electrical system tends to rise. As a result, the risen electric resistance value tends to exceed the prescribed value. In this manner, by monitoring the electric resistance value, a decision for the operating mode can be made.

Therefore, when step S19 determines that the monitored electric resistance value is less than or equal to the prescribed value, the routine returns to step S3. Conversely when step S19 determines that the monitored electric resistance value exceeds the prescribed value, the routine proceeds to step S9.

At step S9, motor drive current stop processing is executed such that the motor drive current to each of the two electrical systems is stopped. At step S10, a failsafe-mode flag is set, and then the routine returns to step S3.

The other processing steps of the control flow are the same as the first embodiment, the fourth embodiment can provide the same operation and effects as the first embodiment.

### Fifth Embodiment

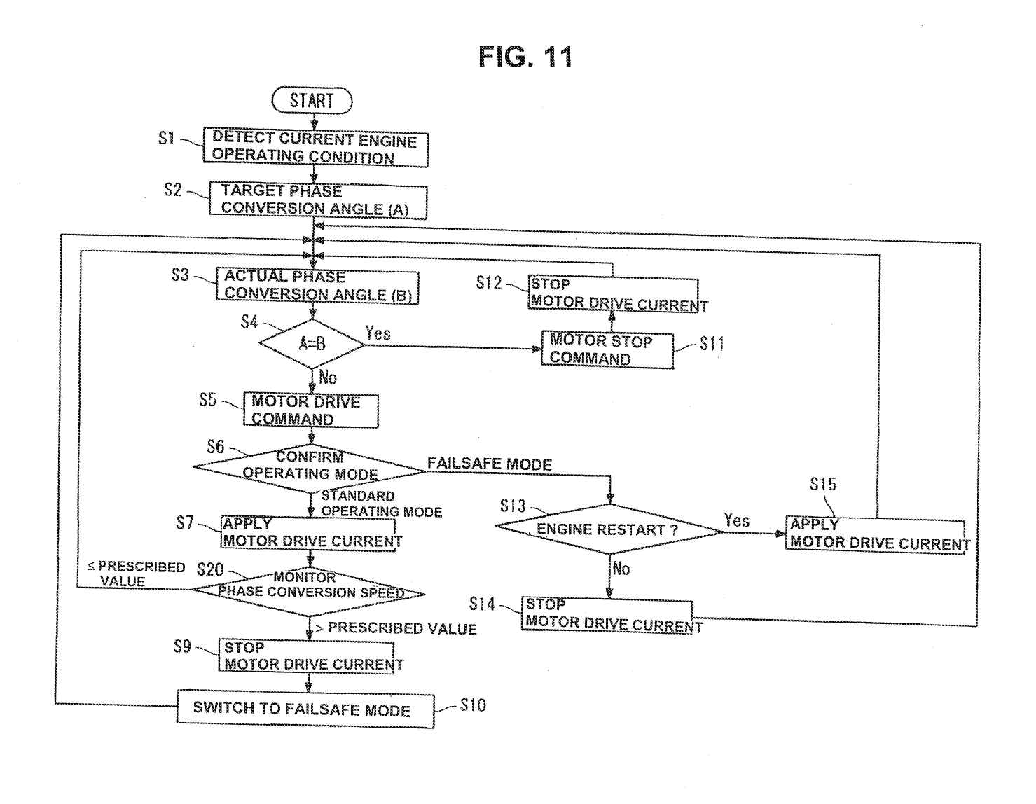

Referring to FIG. 11, there is shown the flowchart of the control flow executed within the control circuit 57 of control unit 56 in the fifth embodiment. The fifth embodiment differs from the first embodiment in that a phase conversion speed of camshaft 2 relative to the crankshaft is monitored instead of motor current value monitoring processing executed at step S8 of FIG. 7 showing the first embodiment.

That is, a phase conversion speed from the current actual phase conversion angle detected or determined based on input information from the crank angle sensor and the cam angle sensor to the target phase conversion angle is arithmetically calculated based on, for instance, the required time for phase-conversion. Thereafter, at step S20, a check is made to determine whether the monitored required time is less than or equal to a prescribed value.

For instance, when any of pigtail harnesses 27a-27d and the like in the two systems is not broken, thus operating in a normal energization state, the required time for phase-conversion becomes less than or equal to the prescribed value, and thus it is determined that these electrical systems are operating normally. Conversely when either one of the electrical systems is broken, with the other electrical system energized, the required time for phase-conversion becomes greater than the prescribed value. In this manner, by monitoring the required time for phase-conversion (i.e., the phase conversion speed), a decision for the operating mode can be made.

Therefore, when step S20 determines that the monitored phase conversion speed is less than or equal to the prescribed value, the routine returns to step S3. Conversely when step S20 determines that the monitored phase conversion speed exceeds the prescribed value, the routine proceeds to step S9 in a similar manner to the embodiment of FIG. 7.

At step S9, motor drive current stop processing is executed such that the motor drive current to each of the two electrical systems is stopped. At step S10, a failsafe-mode flag is set, and then the routine returns to step S3.

The other processing steps of the control flow are the same as the first embodiment, the fifth embodiment can provide the same operation and effects as the first embodiment.

While the foregoing is a description of the preferred embodiments carried out the invention, it will be understood that the invention is not limited to the particular embodiments shown and described herein, but that various changes and modifications may be made. For instance, a broken state of the pigtail harnesses and magnet harnesses may be detected by another method different from the detection methods as described previously.

An object that falls into wire breakage is not limited to only the pigtail harnesses 27a-27d and magnet harnesses 21b, 21c. For instance, coil 18 of the electric motor may be included in such an object.

In the shown embodiments, the valve timing control device installed on the intake valve side of the engine is exemplified. As a matter of course, the valve timing control device may be installed on the exhaust valve side. In this case, when starting the engine, the relative rotational phase of the camshaft is controlled to the maximum phase-advance side by means of the phase converter.

In the flowchart of each of the shown embodiments according to the invention, at step S9 motor drive current stop processing is executed. In lieu thereof, the routine proceeds directly to step S10 without stopping the motor drive current through step S9, so as to attain an abrupt mode-shift to a failsafe mode. In this case, motor drive current application, motor drive current stop, or motor drive current limit has to be determined based on the result of a decision as to whether the engine is restarted.

1. A valve timing control device for an internal combustion engine for changing a relative rotational phase of a camshaft to a crankshaft by energizing a plurality of coils of an electric motor, comprising:
the electric motor having two systems of switching brushes, each of the two systems being constructed by a positive-electrode switching brush and a negative-electrode switching brush,
wherein, when an electricity-feeding line used for electricity-feeding to one system of the two systems of switching brushes or one of the plurality of coils has broken, the valve timing control device is configured to stop energization to the switching brushes or reduce an energization amount to the switching brushes, after having energized the switching brushes until such time that a predetermined time has expired from a start of the engine.

2. The valve timing control device for the internal combustion engine as recited in claim 1, wherein:
an energization amount to the switching brushes energized for the predetermined time from the start of the engine when the electricity-feeding line used for electricity-feeding to the one system of switching brushes or the one of the plurality of coils has broken, is greater than an energization amount when any of the electricity-feeding line used for electricity-feeding to the one system of switching brushes and the one of the plurality of coils is not broken.

3. The valve timing control device for the internal combustion engine as recited in claim 1, wherein:
an energization amount to the other system of switching brushes energized for the predetermined time from the start of the engine is greater than an energization amount when the valve timing control device is controlled by both the two systems of switching brushes.

4. The valve timing control device for the internal combustion engine as recited in claim 1, wherein:
a state where the electricity-feeding line used for electricity-feeding to the one system of switching brushes or the one of the plurality of coils has broken, is detected based on a degradation in relative-rotation responsiveness when a driven rotary member fixed to the camshaft is rotated relatively to a driving rotary member adapted to receive a rotational force transmitted from the crankshaft.

5. The valve timing control device for the internal combustion engine as recited in claim 1, wherein:
a state where the electricity-feeding line used for electricity-feeding to the one system of switching brushes or the one of the plurality of coils has broken, is detected and determined when a value of electric resistance of the energized coil exceeds a prescribed value.

6. A valve timing control device for an internal combustion engine comprising:
a driving rotary member adapted to receive a rotational force transmitted from a crankshaft;
a driven rotary member fixed to a camshaft;
a stator structured to rotate together with either the driving rotary member or the driven rotary member, and configured to generate different magnetic fields in a circumferential direction;
a rotor structured to cause relative rotation of the driven rotary member to the driving rotary member by rotating the rotor relatively to the stator;
a plurality of coils wound on an outer periphery of the rotor;
a pair of electricity-feeding brushes located on a non-rotary side;
a pair of slip rings located on a rotary side and kept in sliding-contact with the respective electricity-feeding brushes;
a positive-electrode switching-brush pair of positive-electrode switching brushes electrically connected to one of the slip rings;
a negative-electrode switching-brush pair of negative-electrode switching brushes electrically connected to the other of the slip rings; and
a commutator located on the rotor and configured such that a first set of positive-electrode and negative-electrode switching brushes constructed by a first positive-electrode switching brush of the positive-electrode switching-brush pair and a first negative-electrode switching brush of the negative-electrode switching-brush pair and a second set of positive-electrode and negative-electrode switching brushes constructed by a second positive-electrode switching brush of the positive-electrode switching-brush pair and a second negative-electrode switching brush of the negative-electrode switching-brush pair are kept in abutted-engagement with the commutator and that both ends of each of the coils electrically connected to the commutator,
wherein, when a requirement of relative rotation of the rotor to the stator is present in a wire-breakage state where it is impossible to energize one set of the two sets of switching brushes, the valve timing control device is configured to:
energize the other set of switching brushes for a predetermined time from a start of the engine; and
stop energization to the other set of switching brushes or reduce an energization amount to the other set of switching brushes, after the predetermined time has expired.

7. The valve timing control device for the internal combustion engine as recited in claim 6, wherein:
a state where one of the plurality of coils or an electricity-feeding line used for electricity-feeding to the one coil has broken, is detected based on a degradation in relative-rotation responsiveness obtained when the driven rotary member is rotated relatively to the driving rotary member.

8. The valve timing control device for the internal combustion engine as recited in claim 6, wherein:
a state where one of the plurality of coils or an electricity-feeding line used for electricity-feeding to the one coil has broken, is detected and determined when a value of electric resistance of the energized coil exceeds a prescribed value.

9. The valve timing control device for the internal combustion engine as recited in claim 7, which further comprises:
an angle detection means that detects a phase angle of the driven rotary member relative to the driving rotary member,
wherein the degradation in relative-rotation responsiveness is determined based on a detected value detected by the angle detection means.

10. The valve timing control device for the internal combustion engine as recited in claim 6, wherein:
the positive-electrode switching brushes of the positive-electrode switching-brush pair are arranged adjacent to each other in the circumferential direction, and the negative-electrode switching brushes of the negative-electrode switching-brush pair are arranged adjacent to each other in the circumferential direction.

11. The valve timing control device for the internal combustion engine as recited in claim 10, wherein:
the first positive-electrode switching brush of the positive-electrode switching-brush pair and the first negative-electrode switching brush of the negative-electrode switching-brush pair are arranged to be spaced apart from each other by 180 degrees in the circumferential direction, and the second positive-electrode switching brush of the positive-electrode switching-brush pair and the second negative-electrode switching brush of the negative-electrode switching-brush pair are arranged to be spaced apart from each other by 180 degrees in the circumferential direction.

12. A controller for a valve timing control device for an internal combustion engine for changing a relative rotational phase of a camshaft to a crankshaft by energizing a plurality of coils of an electric motor on which the plurality of coils are wound, comprising:
a control section configured to perform, when one of the plurality of coils or an electricity-feeding line used for electricity-feeding to the one coil has broken, a specific control mode including:
a first control action of energizing the other coil of the plurality of coils for a predetermined time from a start of the engine; and
a second control action of stopping energization to the other coil or reducing an energization amount to the other coil, after the predetermined time has expired.

13. The controller for the valve timing control device for the internal combustion engine as recited in claim 12, wherein:
the control section is configured to perform, when one of the plurality of coils or an electricity-feeding line used for electricity-feeding to the one coil has broken, another specific control mode including:
a third control action of stopping energization to the other coil; and
a fourth control action of reducing an energization amount to the other coil, when a stop command of the engine or a restart command after having stopped the engine is present.

14. The controller for the valve timing control device for the internal combustion engine as recited in claim 13, wherein:
the control section is configured to perform, when one of the plurality of coils or an electricity-feeding line used for electricity-feeding to the one coil has broken, a further specific control mode including:
a fifth control action of reducing an energization amount to the other coil, only when a restart command after having stopped the engine is present.

15.-16. (canceled)
